(19) United States
(12) Patent Application Publication
(10) Pub. No.: US 2025/0179274 A1
(43) Pub. Date: Jun. 5, 2025

(54) RUBBER COMPOSITION FOR TIRES

(71) Applicant: The Yokohama Rubber Co., LTD., Kanagawa (JP)

(72) Inventors: Kentaro TAKEUCHI, Kanagawa (JP); Ryutaro NAKAGAWA, Kanagawa (JP); Kaori OSUMI, Kanagawa (JP)

(21) Appl. No.: 18/846,140

(22) PCT Filed: Mar. 14, 2023
(86) PCT No.: PCT/JP2023/009846

§ 371 Date: Sep. 11, 2024

(30) Foreign Application Priority Data
Mar. 16, 2022 (JP) 2022-041020

(51) Int. Cl. C08L 9/06; B60C 1/00; C08K 3/36

(52) U.S. Cl. CPC C08L 9/06; B60C 1/0016; C08K 3/36

(57) ABSTRACT

A tire rubber composition contains: 100 parts by mass of a diene rubber containing 55 mass % or more of a solution-polymerized styrene-butadiene rubber whose glass transition temperature is −50° C. or lower; 30 parts by mass or more and less than 100 parts by mass of a white filler; and 15 parts by mass or more of a thermoplastic resin, from 3 to 20 mass % of a silane coupling agent being blended relative to a mass of the white filler. The rubber composition satisfies Tga-Tgm of 10° C. or less, where Tga is a theoretical glass transition temperature of a mixture in which the diene rubber and the thermoplastic resin are blended at a mass ratio of 1:1, Tga being calculated from glass transition temperatures of the diene rubber and the thermoplastic resin, and Tgm is a measured glass transition temperature of the mixture.

### TECHNICAL FIELD

The present technology relates to a rubber composition for a tire having excellent wear resistance and wet performance and achieving satisfactory low rolling resistance in a wide temperature range.

### BACKGROUND ART

A summer tire is required to have high levels of wear resistance, wet performance, and low rolling resistance. For the rubber composition for a tire which has improved wet performance and low rolling resistance, blending of silica and various resin components in a modified styrene-butadiene rubber has been proposed (e.g., see Japan Patent Nos. 5376008 B and 6641300 B).

However, in recent years, it has been demanded to make low rolling resistance excellent in a wider temperature range. Therefore, the technologies described in Japan Patent Nos. 5376008 B and 6641300 B above are not necessarily satisfactory to reduce the temperature dependency of the rolling resistance and to achieve the low rolling resistance in a wider temperature range.

### SUMMARY

The present technology provides a rubber composition for a tire by which excellent wear resistance and wet performance are achieved and rolling resistance and temperature dependency thereof are reduced.

The rubber composition for a tire of the present technology is a rubber composition for a tire, containing: 100 parts by mass of a diene rubber containing 55 mass % or more of a solution-polymerized styrene-butadiene rubber whose glass transition temperature is −50° C. or lower; 30 parts by mass or more and less than 100 parts by mass of a white filler; and 15 parts by mass or more of a thermoplastic resin, from 3 to 20 mass % of a silane coupling agent represented by an average compositional formula of Formula (1) below being blended relative to a mass of the white filler, wherein the rubber composition for a tire satisfies a difference Tga-Tgm between Tga and Tgm of 10° C. or less, where Tga is a theoretical glass transition temperature of a mixture in which the diene rubber and the thermoplastic resin are blended at a mass ratio of 1:1, the theoretical glass transition temperature Tga being calculated from glass transition temperatures of the diene rubber and the thermoplastic resin, and Tgm is a measured glass transition temperature of the mixture:

(A)ₐ(B)_{b}(C)_{c}(D)_{d}(R¹)ₑSiO_{(4-2a-b-c-d-e)/2} (1)

where in Formula (1), A represents a divalent organic group containing a sulfide group, B represents a monovalent hydrocarbon group having from 5 to carbons, C represents a hydrolyzable group, D represents an organic group containing a mercapto group, R¹ represents a monovalent hydrocarbon group having from 1 to 4 carbons, and a to e satisfy the relationships: 0≤a<1, 0<b<<1, 0<c<3, 0<d<1, 0≤e<2, and 0<2a+b+c+d+e<4.

Because the specific thermoplastic resin, the silica, and the specific silane coupling agent are blended in the diene rubber containing the specific solution-polymerized styrene-butadiene rubber in the rubber composition for a tire of the present technology, excellent wear resistance and wet performance can be achieved and rolling resistance can be reduced in a wide temperature range.

In the rubber composition for a tire, a maximum value tan δ_{MAXA} of a loss tangent at from −40° C. to 60° C. of the rubber composition for a tire and a maximum value tan δ_{MAXB} of a loss tangent at from −40° C. to 60° C. of a rubber composition B having the same composition as that of the rubber composition for a tire except that all the thermoplastic resin is replaced with oil preferably satisfy Formula (2) below in relation to the rubber composition B:

tan δ_{MAXA}/tan δ_{MAXB}>0.8 (2).

At least one terminal of the solution-polymerized styrene-butadiene rubber is preferably modified with a functional group, and an oil extension amount of the solution-polymerized styrene-butadiene rubber is preferably 10 parts by mass or less per 100 parts by mass of the solution-polymerized styrene-butadiene rubber.

The thermoplastic resin preferably has a glass transition temperature of from 40° C. to 120° C., and is preferably at least one selected from the group consisting of resins composed of at least one selected from terpenes, terpene phenols, rosins, rosin esters, C5 components, and C9 components, and resins in which at least some of double bonds of these resins are hydrogenated.

A tire including a tread portion containing the rubber composition for a tire described above is particularly suitable as a summer tire and has excellent wear resistance and wet performance, and can have reduced rolling resistance in a wide temperature range.

### DETAILED DESCRIPTION OF EMBODIMENTS

The rubber composition for a tire according to an embodiment of the present technology contains a diene rubber as a rubber component, and 55 mass % or more of a solution-polymerized styrene-butadiene rubber having a glass transition temperature (hereinafter sometimes referred to as “Tg”) of −50° C. or lower is contained in 100 mass % of the diene rubber. Blending of the solution-polymerized styrene-butadiene rubber having a Tg of −50° C. or lower makes dispersibility of the silica good, ensures wear resistance and low rolling resistance, and reduces temperature dependency of rolling resistance. The amount of the solution-polymerized styrene-butadiene rubber having a Tg of −50° C. or lower is 55 mass % or more, preferably from 55 to 80 mass %, and more preferably from 60 to 75 mass %, in 100 mass % of the diene rubber. When the amount of the solution-polymerized styrene-butadiene rubber is less than 55 mass %, an effect of enhancing dispersibility of the silica cannot be adequately achieved, and the temperature dependency of rolling resistance cannot be reduced.

When the Tg of the solution-polymerized styrene-butadiene rubber is higher than −50° C., the temperature dependency of rolling resistance cannot be reduced. The Tg is preferably from −50° C. to −65° C., and more preferably from −50° C. to −60° C. For the Tg of the solution-polymerized styrene-butadiene rubber, differential scanning calorimetry (DSC) is performed at a rate of temperature increase of 20° C./minute to obtain a thermogram, and the temperature at the midpoint of the transition region is defined as the glass transition temperature. When the diene rubber is an oil extended product, the Tg is the Tg of the diene rubber containing no oil-extending component (oil).

At least one terminal of the solution-polymerized styrene-butadiene rubber having a Tg of −50° C. or lower is preferably modified with a functional group, which can make the dispersibility of the silica good and further reduce the rolling resistance of the tire. Examples of the functional group include epoxy group, carboxy group, amino group, hydroxy group, alkoxy group, silyl group, alkoxysilyl group, amide group, oxysilyl group, silanol group, isocyanate group, isothiocyanate group, carbonyl group, and aldehyde group. Among them, a functional group having a polyorganosiloxane structure or an aminosilane structure is preferable. The presence of the functional group having the polyorganosiloxane structure or the aminosilane structure can make the dispersibility of the silica good, and make wet performance and low rolling resistance excellent.

The styrene content of the solution-polymerized styrene-butadiene rubber is not particularly limited and is preferably from 5 to 30 mass %, and more preferably from 8 to 25 mass %. The styrene content in this range is preferred because low rolling resistance of the tire can be achieved. The styrene content of the solution-polymerized styrene-butadiene rubber can be measured by ¹H-NMR.

The vinyl content of the solution-polymerized styrene-butadiene rubber is not particularly limited, and is preferably from 9 to 45 mol %, more preferably from 20 to 45 mol %, even more preferably from 25 to 45 mol %, and particularly preferably from 28 to 42 mol %. The vinyl content in this range is preferred because good dispersibility of the silica and low temperature dependency of rolling resistance can be achieved, and wear resistance can be ensured. The vinyl content of the solution-polymerized styrene-butadiene rubber can be measured by 1H-NMR.

The solution-polymerized styrene-butadiene rubber may contain an oil-extending component. The oil extension amount of the solution-polymerized styrene-butadiene rubber is preferably 10 parts by mass or less per 100 parts by mass of the solution-polymerized styrene-butadiene rubber. By setting the oil extension amount to 10 parts by mass or less, it is possible to suppress deterioration in grip performance after aging of the tire. The oil extension amount is more preferably 8 parts by mass or less, and even more preferably 5 parts by mass or less.

The rubber composition for a tire may contain, as a rubber component, another diene rubber besides the solution-polymerized styrene-butadiene rubber. Examples of the other diene rubber can include solution-polymerized styrene-butadiene rubber, natural rubber, isoprene rubber, butadiene rubber, butyl rubber, emulsion polymerized styrene-butadiene rubber, halogenated butyl rubber, acrylonitrile-butadiene rubber, and modified rubbers obtained by adding a functional group to these rubbers, each having a Tg of higher than −50° C. The other diene rubber may be used alone or as a discretionary blend. The content of the other diene rubber is preferably 45 mass % or less, more preferably from 20 to 45 mass %, and even more preferably from 25 to 40 mass % in 100 mass % of the diene rubber.

The rubber composition for a tire preferably contains a solution-polymerized styrene-butadiene rubber having a Tg of higher than −50° C. because wet performance is improved. The amount of the solution-polymerized styrene-butadiene rubber having a Tg of higher than −50° C. is preferably from 10 to 25 mass %, and more preferably from 10 to 15 mass %, in 100 mass % of the diene rubber. As the solution-polymerized styrene-butadiene rubber having a Tg of higher than −50° C., a solution-polymerized styrene-butadiene rubber that is ordinarily used in a rubber composition for a tire may be used.

Blending of a natural rubber in the rubber composition for a tire can reduce the temperature dependency of rolling resistance. The amount of the natural rubber is preferably from 5 to 40 mass %, and more preferably from 15 to 30 mass %, in 100 mass % of the diene rubber. As the natural rubber, a natural rubber that is ordinarily used in a rubber composition for a tire is preferably used.

Furthermore, blending of butadiene rubber is preferred because wear resistance is improved. The content of the butadiene rubber is preferably from 5 to 20 mass %, and more preferably from 5 to 15 mass %, in 100 mass % of the diene rubber. As the butadiene rubber, a natural rubber that is ordinarily used in a rubber composition for a tire is preferably used.

The rubber composition for a tire contains 30 parts by mass or more and less than 100 parts by mass of a white filler in 100 parts by mass of the diene rubber. Blending of the white filler can result in excellent wet performance and low rolling resistance. Examples of the white filler include silica, calcium carbonate, magnesium carbonate, talc, clay, alumina, aluminum hydroxide, titanium oxide, and calcium sulfate. One type of these can be used alone, or a combination of two or more types of these can be used. Among them, silica is preferable, and the wet performance and the low heat build-up property can be made more excellent. When the amount of the white filler is less than 30 parts by mass, wet performance and/or low rolling resistance become(s) unsatisfactory. When the amount of the white filler is 100 parts by mass or more, low rolling resistance deteriorates conversely. The white filler is preferably blended in an amount of 40 parts by mass or more and less than 100 parts by mass, and more preferably 45 parts by mass or more and less than 100 parts by mass. As the silica, silica ordinarily used in a rubber composition for a tire is preferably used. For example, wet silica, dry silica, carbon-silica in which silica is carried on a carbon black surface (dual-phase filler), and silica that is surface-treated with a compound having reactivity or miscibility with both silica and rubber, such as a silane coupling agent or polysiloxane, can be used. Among these, a wet silica having hydrous silicic acid as a main component is preferred.

Furthermore, blending of a silane coupling agent represented by an average compositional formula of Formula (1) below together with the silica is preferred because dispersibility of the silica is improved and wet performance and low rolling resistance are further improved:

(A)ₐ(B)_{b}(C)_{c}(D)_{d}(R¹)ₑSiO_{(4-2a-b-c-d-e)/2} (1)

where in Formula (1), A represents a divalent organic group containing a sulfide group, B represents a monovalent hydrocarbon group having from 5 to carbons, C represents a hydrolyzable group, D represents an organic group containing a mercapto group, R¹ represents a monovalent hydrocarbon group having from 1 to 4 carbons, and a to e satisfy the relationships: 0≤a<1, 0<b <1, 0<c<3, 0<d<1, 0≤e<2, and 0<2a+b+c+d+e<4.

The silane coupling agent represented by Formula (1) above preferably includes a polysiloxane backbone. The polysiloxane backbone may be a straight-chain, branched, or three-dimensional structure, or a combination of these.

In Formula (1) above, the hydrocarbon group B is a monovalent hydrocarbon group having from 5 to 10 carbons, preferably a monovalent hydrocarbon group having from 6 to 10 carbons, and more preferably a monovalent hydrocarbon group having from 8 to 10 carbons. Examples thereof include a hexyl group, an octyl group, and a decyl group. In this way, the mercapto group is protected, Mooney scorch time is made longer, superior processability (scorch resistance) is achieved, and even better low rolling resistance can be achieved. The subscript b of the hydrocarbon group B is more than 0 and preferably satisfies 0.10≤b≤0.89.

Furthermore, in Formula (1) above, the organic group A represents a divalent organic group containing a sulfide group (hereinafter, also referred to as “sulfide group-containing organic group”). When the sulfide group-containing organic group A is contained, even better low heat build-up and processability (especially sustenance and prolongation of Mooney scorch time) are achieved. Thus, the subscript a of the sulfide group-containing organic group A is preferably more than 0, and more preferably satisfies 0<a≤0.50. The sulfide group-containing organic group A may contain a heteroatom such as an oxygen atom, a nitrogen atom, or a sulfur atom.

Among these, the sulfide group-containing organic group A is preferably a group represented by Formula (3) below.

*—(CH₂)ₙ-Sx-(CH₂)ₙ—* (3)

In Formula (3) above, n represents an integer of 1 to 10, x represents an integer of 1 to 6, and * represents a bonding position.

Specific examples of the sulfide group-containing organic group A represented by General Formula (3) above include *—CH₂—S₂—CH₂—*, *—C₂H₄—S₂—C₂H₄—*, *—C₃H₆—S₂—C₃H₆—*, *—C₄H₈—S₂—C₄H₈—*, *—CH₂—S₄—CH₂—*, *—C₂H₄—S₄—C₂H₄—*, *—C₃H₆—S₄—C₃H₆—*, and *—C₄H₈—S₄—C₄H₈—*.

The silane coupling agent containing the polysiloxane represented by the average compositional formula of General Formula (1) above has excellent affinity and/or reactivity with silica due to having a hydrolyzable group C. The subscript c of the hydrolyzable group C in General Formula (1) preferably satisfies 1.2≤c≤2.0 because even better low heat build-up and processability (scorch resistance) are achieved and even better dispersibility of the silica is achieved. Specific examples of the hydrolyzable group C include an alkoxy group, a phenoxy group, a carboxyl group, an alkenyloxy group, and the like. From the perspective of achieving good dispersibility of silica and even better processability (scorch resistance), the hydrolyzable group C is preferably a group represented by General Formula (4) below.

*—OR² (4)

In General Formula (4) above, * represents a bonding position. Furthermore, R² represents an alkyl group having from 1 to 20 carbons, an aryl group having from 6 to 10 carbons, an aralkyl group (aryl-alkyl group) having from 6 to 10 carbons, or an alkenyl group having from 2 to 10 carbons. Among these, an alkyl group having from 1 to 5 carbons is preferred.

Specific examples of the alkyl group having from 1 to 20 carbons include a methyl group, an ethyl group, a propyl group, a butyl group, a hexyl group, an octyl group, a decyl group, and an octadecyl group. Specific examples of the aryl group having from 6 to 10 carbons include a phenyl group, and a tolyl group. Specific examples of the aralkyl group having from 6 to 10 carbons include a benzyl group, and a phenylethyl group. Specific examples of the above alkenyl group having from 2 to 10 carbons include a vinyl group, a propenyl group, a pentenyl group, and the like.

Since the silane coupling agent containing polysiloxane represented by the average compositional formula of General Formula (1) above has an organic group D containing a mercapto group, the silane coupling agent can interact and/or react with the diene rubber, and thus excellent low heat build-up is achieved. The subscript d of the organic group D containing a mercapto group preferably satisfies 0.1≤d≤0.8. From the perspective of achieving good dispersibility of silica and even better processability (scorch resistance), the organic group D containing a mercapto group is preferably a group represented by General Formula (5) below.

*—(CH₂)ₘ—SH (5)

In General Formula (5) above, m represents an integer of from 1 to 10, and particularly preferably an integer of from 1 to 5. In the formula, * represents a bonding position.

Specific examples of the group represented by General Formula (5) above include *—CH₂SH, *—C₂H₄SH, *—C₃H₆SH, *—C₄H₈SH, *—C₅H₁₀SH, *—C₆H₁₂SH, *—C₇H₁₄SH, *—C₈H₁₆SH, *—C₉H₁₈SH, and *—C₁₀H₂₀SH.

In General Formula (1) above, R¹ represents a monovalent hydrocarbon group having from 1 to 4 carbons. Examples of the hydrocarbon group R¹ include a methyl group, an ethyl group, a propyl group, and a butyl group.

The blended amount of the silane coupling agent is from 3 to 20 mass %, and preferably from 5 to 15 mass %, relative to the mass of the silica. When the blended amount of the silane coupling agent is less than 3 mass % of the silica mass, the effect of improving the dispersibility of the silica cannot be adequately achieved. Furthermore, when the blended amount of the silane coupling agent is more than 20 mass %, the diene rubber component tends to be gelled, and thus the desired effect cannot be achieved.

By blending another filler besides the white filler in the rubber composition for a tire, the strength of the rubber composition can be made high, and tire durability can be ensured. Examples of the other filler include an inorganic filler such as carbon black, mica, aluminum oxide, and barium sulfate; and an organic filler such as cellulose, lecithin, lignin, and dendrimer.

In particular, by blending the carbon black, excellent strength of the rubber composition can be achieved. As the carbon black, a carbon black such as furnace black, acetylene black, thermal black, channel black, and graphite can be blended. Of these, furnace black is preferred. Specific examples thereof include SAF (Super Abrasion Furnace), ISAF (Intermediate Super Abrasion Furnace), ISAF-HS (Intermediate Super Abrasion Furnace-High Structure), ISAF-LS (Intermediate Super Abrasion Furnace-Low Structure), IISAF-HS (Intermediate Intermediate Super Abrasion Furnace-High Structure), HAF (High Abrasion Furnace), HAF-HS (High Abrasion Furnace-High Structure), HAF-LS (High Abrasion Furnace-Low Structure), and FEF (Fast Extruding Furnace). One type of these carbon blacks may be used alone, or a combination of two or more types of these carbon blacks may be used. Furthermore, surface-treated carbon blacks, in which these carbon blacks are chemically modified with various acid compounds, can also be used.

When the rubber composition for a tire contains the specific thermoplastic resin, the temperature dependency of dynamic visco-elasticity can be adjusted. The specific thermoplastic resin is blended in an amount of 15 parts by mass or more, preferably 20 parts by mass or more, and more preferably 25 parts by mass or more per 100 parts by mass of the diene rubber. When the amount of the thermoplastic resin is less than 15 parts by mass, obtaining excellent wear resistance and wet performance and reducing rolling resistance and temperature dependency thereof, cannot be achieved. Also, the specific thermoplastic resin is blended in an amount of preferably 75 parts by mass or less, and more preferably 60 parts by mass or less per 100 parts by mass of the diene rubber. When the amount of the specific thermoplastic resin is more than 75 parts by mass, wear resistance may deteriorate.

The specific thermoplastic resin satisfies the following relationship with the diene rubber. That is, a difference Tga-Tgm between Tga and Tgm is 10° C. or less, where Tga is a theoretical glass transition temperature of a mixture in which the diene rubber and the thermoplastic resin described above are blended at a mass ratio of 1:1, the theoretical glass transition temperature Tga being calculated from glass transition temperatures of the diene rubber and the thermoplastic resin, and Tgm is a measured glass transition temperature of the mixture. By having the difference Tga-Tgm be 10° C. or less, the wear resistance and the wet performance can be excellent, the rolling resistance can be reduced, and the temperature dependency thereof can be reduced. The difference Tga-Tgm is preferably 7° C. or less, and more preferably 5° C. or less. When the difference Tga-Tgm is 10° C. or less, it is considered that the diene rubber and the thermoplastic resin are in a compatible relationship, and that, by blending a relatively large amount of the thermoplastic resin, the tensile strength at break of the rubber composition is increased, which contributes to improvement in visco-elastic properties such as tan δ. In the present specification, the theoretical glass transition temperature (Tga) of the mixture can be calculated as a weighted average value based on the glass transition temperatures and the mass ratio of the diene rubber and the thermoplastic resin. The glass transition temperatures (Tg) of the diene rubber and the thermoplastic resin, and the glass transition temperature (Tgm) of the mixture, are measured values obtained by performing differential scanning calorimetry (DSC) at a rate of temperature increase of 20° C./min to obtain a thermogram and thereby obtain the temperature at the midpoint of the transition region as the glass transition temperatures Tg or Tgm. When there is a plurality of transition regions in the thermogram, the midpoint in the largest transition region is taken as the glass transition temperature Tgm of the mixture.

The thermoplastic resin is a resin usually blended in a rubber composition for a tire, has a molecular weight of about several hundreds to several thousands, and has a function of imparting adhesiveness to the rubber composition for a tire. The thermoplastic resin is preferably a resin composed of at least one selected from the group consisting of resins composed of at least one selected from terpenes, modified terpenes, rosins, rosin esters, C5 components, and C9 components, and resins in which at least some of double bonds of these resins are hydrogenated. Examples of the resin include natural resins such as a terpene resins, modified terpene resins, rosin resins, and rosin ester resins, synthetic resins such as petroleum resins including C5 components and C9 components, coal resins, phenol resins, and xylene resins, and hydrogenated resins obtained by hydrogenating at least some of double bonds of these natural resins and synthetic resins.

Examples of the terpene resins include α-pinene resin, β-pinene resin, limonene resin, hydrogenated limonene resin, dipentene resin, terpene phenol resin, terpene styrene resin, aromatic modified terpene resin, and hydrogenated terpene resin. Examples of the rosin resins include modified rosins such as gum rosin, tall oil rosin, wood rosin, hydrogenated rosin, disproportionate rosin, polymerized rosin, maleated rosin, and fumarized rosin; ester derivatives of these rosins such as glycerine esters, pentaerythritol esters, methyl esters, and triethylene glycol esters; and rosin modified phenol resin.

Examples of the petroleum resin include aromatic hydrocarbon resins or, alternatively, saturated or unsaturated aliphatic hydrocarbon resins. Examples thereof include C5 petroleum resins (aliphatic petroleum resins formed by polymerizing fractions such as isoprene, 1,3-pentadiene, cyclopentadiene, methylbutene, pentene, and the like), C9 petroleum resins (aromatic petroleum resins formed by polymerizing fractions such as α-methylstyrene, o-vinyl toluene, m-vinyl toluene, p-vinyl toluene, and the like), C5C9 copolymerization petroleum resins, and resins obtained by hydrogenating these resins.

The glass transition temperature (Tg) of the thermoplastic resin is preferably from 40° C. to 120° C., preferably from 45° C. to 115° C., and more preferably from 50° C. to 110° C. A Tg of the thermoplastic resin of 40° C. or higher is preferred because wet performance is improved. Additionally, a Tg of 120° C. or lower of the thermoplastic resin is preferred because wear resistance is improved. The Tg of the thermoplastic resin can be measured by the method described above.

In the following description, the rubber composition for a tire of the present technology is referred to as rubber composition A, and a rubber composition having the same composition as that of the rubber composition A except that all the thermoplastic resin contained in the rubber composition A is replaced with oil is referred to as rubber composition B. A maximum value of a loss tangent at from −40° C. to 60° C. of the rubber composition A is defined as tan δ_{MAXA}, and a maximum value of a loss tangent at from −40° C. to 60° C. of the rubber composition B is defined as tan δ_{MAXB}. In this case, the tan δ_{MAXA} and the tan δ_{MAXB} preferably satisfy a relationship of Formula (2) below: tan δ_{MAXA}/tan δ_{MAXB}>0.8 (2).

A ratio tan δ_{MAXA}/tan δ_{MAXB} between the maximum values of the loss tangents of more than 0.8 is preferred because the tensile strength at break of the rubber composition for a tire of the present technology (rubber composition A) becomes large, and the wear resistance when it is formed into a tire becomes more excellent. The rubber composition B tends to have high compatibility between the diene rubber and the oil contained therein and high tensile strength at break. When the tan δ_{MAXA} of the rubber composition A is close to the tan δ_{MAXB} of the rubber composition B, it is inferred that the visco-elastic behaviors of the rubber compositions are similar to each other, that the compatibility between the diene rubber and the thermoplastic resin is good, that the thermoplastic resin is prevented from becoming a starting point of breakage, and that the tensile strength at break is increased. The ratio tan δ_{MAXA}/tan δ_{MAXB} is more preferably more than 0.85 and even more preferably more than 0.9. In the present specification, the tan δ_{MAXA} and the tan δ_{MAXB} can be obtained by measuring the dynamic visco-elasticity of cured products of the rubber compositions A and B using a visco-elastic spectrometer under conditions of an elongation deformation strain rate of 10±2%, a vibration frequency of 20 Hz, and a temperature of from −40° C. to 60° C., obtaining a visco-elastic curve with the measurement temperature on the horizontal axis and the loss tangent (tan δ) on the vertical axis, and taking thickest values (peak values) of the tan δ as tan δ_{MAXA} and tan δ_{MAXB}, respectively.

In addition to the components described above, the rubber composition for a tire may also contain various compounding agents that are commonly used in rubber compositions for tire treads, in accordance with an ordinary method. Examples of the compounding agents include a vulcanization or crosslinking agent, a vulcanization accelerator, an anti-aging agent, a processing aid, a plasticizer, a liquid polymer, and a thermosetting resin. These compounding agents can be kneaded by a common method to obtain a rubber composition that can then be used for vulcanization or crosslinking. These compounding agents can be compounded in known general amounts so long as the present technology is not hindered. The rubber composition for a tire can be prepared by mixing the above-mentioned components using a known rubber kneading machine such as a Banbury mixer, a kneader, or a roller.

The rubber composition for a tire is suitable for forming a tread portion or a side portion of a summer tire and especially suitable for forming a tread portion of a summer tire. The summer tire obtained by this has excellent wear resistance and wet performance and can have reduced rolling resistance and temperature dependency thereof beyond known levels.

Embodiments according to the present technology are further described below by Examples. However, the scope of the present technology is not limited to these Examples.

### EXAMPLES

For preparing 21 types of rubber compositions for a tire (Standard Example, Examples 1 to 11, and Comparative Examples 1 to 9) containing the common additive formulation indicated in Table 3 and having the blends indicated in Tables 1 and 2, components other than sulfur and vulcanization accelerators were weighed and kneaded in a 1.7 L sealed Banbury mixer for 5 minutes. Then, a master batch was discharged outside the mixer and cooled at room temperature. The master batch was placed in the Banbury mixer, and a sulfur and vulcanization accelerators were then added and mixed to obtain each of the rubber compositions for a tire. Regarding Comparative Example 9 in Table 1, SBR-4 is an oil extended product having an oil extension amount of 25 parts by mass, and thus the blended amount without the oil-extending component is shown in parentheses in the lower part. Furthermore, the additive formulation in Table 3 is expressed as values in parts by mass per 100 parts by mass of the diene rubbers listed in Tables 1 and 2. Each of the rubber compositions for a tire of Examples 1 to 11 and Comparative Examples 1 to 9 described above is referred to as rubber composition A, and a rubber composition having the same composition as that of the rubber composition A except that all the thermoplastic resin contained in the rubber composition A was replaced with oil is referred to as rubber composition B. Furthermore, a mixture was prepared by blending the diene rubber and the thermoplastic resin constituting the rubber composition for a tire of each of the Examples and the Comparative Examples at a mass ratio of 1:1, the glass transition temperature (Tgm) of the mixture was measured by the above-described method, the theoretical glass transition temperature Tga was calculated, and the difference Tga-Tgm of Tga from the measured glass transition temperature Tgm was calculated and shown in Tables 1 and 2.

The rubber composition for a tire obtained as described above was vulcanized at 160° C. for 20 minutes in a mold having a predetermined form, and thus an evaluation sample was produced. Using the obtained evaluation sample, dynamic visco-elasticity (loss tangent tan δ), wear resistance, wet performance, rolling resistance, and temperature dependency of rolling resistance were measured by the following methods.

### Dynamic Visco-Elasticity (Loss Tangent Tan δ)

The dynamic visco-elasticities of the evaluation samples of the obtained rubber composition for a tire (rubber composition A) and the rubber composition B were measured using a visco-elastic spectrometer available from Iwamoto Seisakusho Co., Ltd. under conditions of an elongation deformation strain rate of 10±2%, a vibration frequency of 20 Hz, and a temperature of from −40° C. to 60° C.; a visco-elastic curve at from −40° C. to 60° C. was prepared; and tan δ_{MAXA}/tan δ_{MAXB} was calculated, where thickest values (peak values) of the tan δ of the rubber composition A and the rubber composition B were tan δ_{MAXA} and tan δ_{MAXB}. The obtained results are shown in Tables 1 and 2.

In addition, a measured value of tan δ at 0° C. of the rubber composition for a tire (rubber composition A) was used as an index of wet performance, and shown in the rows of “wet performance” in Tables 1 and 2 as an index value with tan δ at 0° C. of the Standard Example being assigned the value of 100. A larger index value means superior wet performance.

### Wear Resistance

Using a Lambourn abrasion test machine (available from Iwamoto Seisakusho K.K.), an amount of wear of the evaluation sample of the obtained rubber composition for a tire was measured in accordance with JIS (Japanese Industrial Standard) K6264 under the following conditions: a load of 15.0 kg (147.1 N) and a slip rate of 25%. A reciprocal for each of the obtained results was calculated, and shown in the rows of “wear resistance” in Tables 1 and 2 as an index value with a reciprocal of the amount of wear of the Standard Example being assigned the value of 100. A larger index value of wear resistance means superior wear resistance.

### Rolling Resistance

A 17 inch pneumatic tire in which the rubber composition for a tire obtained above was used in tread rubber was vulcanization-molded. The test tires were assembled on wheels having a standard rim size, and mounted on a rolling resistance tester provided with a 854 mm-radius drum, and pre-running was performed for 30 minutes under conditions of an air pressure of 210 kPa, a load of 100 N, a speed of 80 km/h, and a drum surface temperature of 20° C. after which rolling resistance was measured under the same conditions. For the evaluation results, reciprocals of measured values were used and shown in the rows of “low rolling resistance” in Tables 1 and 2 as index values with a reciprocal thereof of the Standard Example being assigned the value of 100. A larger index value of rolling resistance means smaller rolling resistance and hence superior results.

### Temperature Dependency of Rolling Resistance

The rolling resistance at a tire surface temperature of 20° C. and the rolling resistance at a tire surface temperature of 40° C. were evaluated under the same conditions as the conditions for measuring the rolling resistance. The measured rolling resistance was plotted against the temperature, and the slope of the difference in rolling resistance at each temperature was evaluated as the temperature dependency of the rolling resistance. A smaller slope of rolling resistance means lower temperature dependency of rolling resistance. For the evaluation results, reciprocals of the temperature dependency (slope) of rolling resistance were used and shown in the rows of “temperature dependency of low rolling resistance” in Tables 1 and 2 as index values with a reciprocal thereof of the Standard Example being assigned the value of 100. A larger index value of temperature dependency of rolling resistance means smaller temperature dependency of rolling resistance and hence superior results.

TABLE 1-1

| | | Standard | Comparative | Comparative | Comparative | Comparative |
|---|---|---|---|---|---|---|
| | | Example | Example 1 | Example 2 | Example 3 | Example 4 |
| SBR-1 | Parts by mass | 50 | 80 | 80 | 30 | 80 |
| SBR-2 | Parts by mass | 50 | 20 | 20 | 70 | 20 |
| SBR-3 | Parts by mass | | | | | |
| SBR-4 | Parts by mass | | | | | |
| Carbon black | Parts by mass | 10 | 10 | 10 | 10 | 10 |
| Silica-1 | Parts by mass | 70 | 70 | 70 | 70 | 25 |
| Coupling | Parts by mass | 6 | 6 | | 6 | 2.2 |
| agent-1 | | | | | | |
| Coupling | Parts by mass | | | 6 | | |
| agent-2 | | | | | | |
| Resin-1 | Parts by mass | | | 40 | 40 | 40 |
| Resin-4 | Parts by mass | | 40 | | | |
| Resin-5 | Parts by mass | | | | | |
| Oil | Parts by mass | 40 | | | | |
| Difference | ° C. | — | 25 | 4 | 6 | 4 |
| Tga − Tgm | | | | | | |
| Ratio tan | — | — | 0.4 | 0.8 | 0.52 | 0.8 |
| δ_{MAXA}/tan | | | | | | |
| δ_{MAXB} | | | | | | |
| Wear | Index value | 100 | 78 | 103 | 90 | 83 |
| Resistance | | | | | | |
| Wet | Index value | 100 | 100 | 102 | 110 | 73 |
| performance | | | | | | |
| Low rolling | Index value | 100 | 92 | 95 | 93 | 110 |
| resistance | | | | | | |
| Temperature | Index value | 100 | 86 | 110 | 92 | 105 |
| dependency | | | | | | |
| of low rolling | | | | | | |
| resistance | | | | | | |

TABLE 1-2

| | | Comparative | Comparative | Comparative | Comparative | Comparative |
|---|---|---|---|---|---|---|
| | | Example 5 | Example 6 | Example 7 | Example 8 | Example 9 |
| SBR-1 | Parts by mass | 80 | 80 | 80 | | |
| SBR-2 | Parts by mass | 20 | 20 | 20 | 20 | 20 |
| SBR-3 | Parts by mass | | | | 80 | |
| SBR-4 | Parts by mass | | | | | 100 |
| | | | | | | (80) |
| Carbon black | Parts by mass | 10 | 10 | 10 | 10 | 10 |
| Silica-1 | Parts by mass | 120 | 70 | 70 | 70 | 70 |
| Coupling | Parts by mass | 10.3 | 2 | 6 | 6 | 6 |
| agent-1 | | | | | | |
| Coupling | Parts by mass | | | | | |
| agent-2 | | | | | | |
| Resin-1 | Parts by mass | 40 | 40 | 40 | 40 | 40 |
| Resin-4 | Parts by mass | | | | | |
| Resin-5 | Parts by mass | | | 40 | | |
| Oil | Parts by mass | | | | | |
| Difference | ° C. | 4 | 4 | 16 | 6 | 6 |
| Tga − Tgm | | | | | | |
| Ratio tan | — | 0.8 | 0.8 | 0.5 | 0.5 | 0.6 |
| δ_{MAXA}/tan | | | | | | |
| δ_{MAXB} | | | | | | |
| Wear | Index value | 112 | 96 | 82 | 86 | 98 |
| Resistance | | | | | | |
| Wet | Index value | 105 | 94 | 100 | 115 | 103 |
| performance | | | | | | |
| Low rolling | Index value | 73 | 88 | 94 | 84 | 93 |
| resistance | | | | | | |
| Temperature | Index value | 90 | 87 | 88 | 83 | 89 |
| dependency | | | | | | |
| of low rolling | | | | | | |
| resistance | | | | | | |

TABLE 2-1

| | | Example | Example | Example | Example | Example | Example |
|---|---|---|---|---|---|---|---|
| | | 1 | 2 | 3 | 4 | 5 | 6 |
| NR | Parts by mass | | | 20 | | | |
| SBR-1 | Parts by mass | 80 | 60 | 80 | 80 | 80 | 80 |
| SBR-2 | Parts by mass | 20 | 40 | | 20 | 20 | 20 |
| BR | Parts by mass | | | | | | |
| Carbon black | Parts by mass | 10 | 10 | 10 | 10 | 10 | 10 |
| Silica-1 | Parts by mass | 70 | 70 | 70 | 70 | 70 | 70 |
| Silica-2 | Parts by mass | | | | | | |
| Coupling agent-1 | Parts by mass | 6 | 6 | 6 | 6 | 6 | 6 |
| Coupling agent-2 | Parts by mass | | | | | | |
| Resin-1 | Parts by mass | 40 | 40 | 40 | 20 | 60 | |
| Resin-2 | Parts by mass | | | | | | 40 |
| Resin-3 | Parts by mass | | | | | | |
| Oil | Parts by mass | | | | | | |
| Difference | ° C. | 4 | 5 | 6 | 4 | 4 | 4 |
| Tga − Tgm | | | | | | | |
| Ratio tan | — | 0.85 | 0.87 | 0.86 | 0.92 | 0.83 | 0.84 |
| δ_{MAXA}/tan | | | | | | | |
| δ_{MAXB} | | | | | | | |
| Wear Resistance | Index value | 116 | 108 | 121 | 105 | 124 | 116 |
| Wet performance | Index value | 104 | 110 | 102 | 102 | 124 | 104 |
| Low rolling | Index value | 104 | 104 | 105 | 106 | 110 | 104 |
| resistance | | | | | | | |
| Temperature | Index value | 110 | 107 | 110 | 104 | 125 | 110 |
| dependency of low | | | | | | | |
| rolling resistance | | | | | | | |

TABLE 2-2

| | | Example | Example | Example | Example | Example |
|---|---|---|---|---|---|---|
| | | 7 | 8 | 9 | 10 | 11 |
| NR | Parts by mass | | | | | |
| SBR-1 | Parts by mass | 80 | 80 | 80 | 80 | 80 |
| SBR-2 | Parts by mass | 20 | 20 | 20 | 20 | |
| BR | Parts by mass | | | | | 20 |
| Carbon | Parts by mass | 10 | 10 | 10 | 10 | 10 |
| black | | | | | | |
| Silica-1 | Parts by mass | 70 | 70 | 70 | 20 | 70 |
| Silica-2 | Parts by mass | | | | 50 | |
| Coupling | Parts by mass | 6 | 8 | 4 | 6 | 6 |
| agent-1 | | | | | | |
| Coupling | Parts by mass | | | 2 | | |
| agent-2 | | | | | | |
| Resin-1 | Parts by mass | | 40 | 40 | 40 | 40 |
| Resin-2 | Parts by mass | | | | | |
| Resin-3 | Parts by mass | 35 | | | | |
| Oil | Parts by mass | | | | | |
| Difference | ° C. | 5 | 4 | 4 | 4 | 6 |
| Tga − Tgm | | | | | | |
| Ratio tan | — | 0.84 | 0.85 | 0.85 | 0.85 | 0.83 |
| δ_{MAXA}/tan | | | | | | |
| δ_{MAXB} | | | | | | |
| Wear | Index value | 113 | 112 | 112 | 110 | 122 |
| Resistance | | | | | | |
| Wet | Index value | 105 | 102 | 105 | 106 | 102 |
| performance | | | | | | |
| Low rolling | Index value | 104 | 108 | 103 | 110 | 106 |
| resistance | | | | | | |
| Temperature | Index value | 110 | 112 | 108 | 130 | 110 |
| dependency | | | | | | |
| of low | | | | | | |
| rolling | | | | | | |
| resistance | | | | | | |

Types of raw materials used as indicated in Tables 1 and 2 are described below.
NR: Natural rubber; TSR 20; glass transition temperature: −65° C.
SBR-1: Terminal-modified solution-polymerized styrene-butadiene rubber having a polyorganosiloxane structure; Nipol NS612, available from Zeon Corporation; glass transition temperature: −61° C.; styrene content: 15 mass %; vinyl content: 31 mol %; non-oil extended product
SBR-2: Terminal-modified solution-polymerized styrene-butadiene rubber having a polyorganosiloxane structure; Nipol NS616, available from Zeon Corporation; glass transition temperature: −23° C.; styrene content: 22 mass %; vinyl content: 67 mol %; non-oil extended product
SBR-3: Terminal-modified solution-polymerized styrene-butadiene rubber manufactured by batch polymerization; HPR850, available from JSR Corporation; glass transition temperature: −25° C.; styrene content: 27 mass %; vinyl content: 59 mol %; non-oil extended product
SBR-4: Alkoxysilane-modified solution-polymerized styrene-butadiene rubber manufactured by continuous polymerization; M2520, available from LG; glass transition temperature: −48° C.; styrene content: 27 mass %; vinyl content: 27 mol %; oil extension amount: 25 parts by mass.
BR: Butadiene rubber; Nipol BR1220, available from Zeon Corporation; glass transition temperature: −105° C.
Carbon black: SEAST 7HM, available from Tokai Carbon Co., Ltd.
Silica-1: Zeosil 1165MP, available from Solvay; nitrogen adsorption specific surface area: 159 m²/g
Silica-2: ULTRASIL 5000 GR, available from Evonik Industries AG; nitrogen adsorption specific surface area: 126 m²/g
Coupling agent-1: Silane coupling agent containing polysiloxane represented by the average compositional formula of General Formula (1); polysiloxane adjusted by the production method described in WO 2014/002750 and represented by the average compositional formula (—C₃H₆—S₄—C₃H₆—)_{0.083}(—C₈H₁₇)_{0.667}(—OC₂H₅)_{1.50}(—C₃H₆SH)_{0.167}SiO_{0.75}; average molecular weight: 860
Coupling agent-2: Silane coupling agent; Si69, available from Evonik Degussa
Resin-1: Aromatic modified terpene resin; HSR-7, available from Yasuhara Chemical Co., Ltd.; glass transition temperature: 72° C.
Resin-2: Aromatic modified terpene resin; YS resin TO-105, available from Yasuhara Chemical Co., Ltd.; glass transition temperature: 57° C.
Resin-3: Indene resin; FMR0150, available from Mitsui Chemicals, Inc.; glass transition temperature: 89° C.
Resin-4: Phenol modified terpene resin; Tamanol 803L, available from Arakawa Chemical Industries, Ltd.; glass transition temperature: 95° C.
Resin-5: Polyterpene resin; Sylvatraxx8115, available from Kraton Corporation; glass transition temperature: 67° C.
Oil: Extract 4S, available from Shell Lubricants Japan K.K.

TABLE 3
Common additive formulation

| | |
|---|---|
| Anti-aging agent | 3.0 Parts by mass |
| Wax | 1.0 Parts by mass |
| Sulfur | 2.0 Parts by mass |
| Vulcanization accelerator | 2.5 Parts by mass |

Types of raw materials used as indicated in Table 3 are described below.
Anti-aging agent: VULANOX 4020, available from Lanxess AG
Wax: OZOACE-0015A, available from Nippon Seiro Co., Ltd.
Sulfur: SULFAX 5, available from Tsurumi Chemical Industry Co., Ltd.
Vulcanization accelerator: NOCCELER TOT-N, available from Ouchi Shinko Chemical Industrial Co., Ltd.

As can be seen from Table 2, it was confirmed that the rubber composition for a tire of each of Examples 1 to 11 achieved excellent wear resistance, wet performance, and low rolling resistance, and reduced the temperature dependency of rolling resistance.

As is clear from Table 1, the rubber composition for a tire of Comparative Example 1 exhibits poor wear resistance and cannot have reduced rolling resistance or temperature dependency thereof since the difference Tga-Tgm exceeds 10° C.

Since the rubber composition for a tire of Comparative Example 2 used a silane coupling agent (coupling agent-2) that is not represented by the average compositional formula of Formula (1), the rolling resistance is increased.

The rubber composition for a tire of Comparative Example 3 cannot have improved wear resistance, rolling resistance, or temperature dependency thereof because the content of the solution-polymerized styrene-butadiene rubber (SBR-1) having a Tg of −50° C. or less was less than 55 mass %.

The rubber composition for a tire of Comparative Example 4 cannot have improved wear resistance or wet performance, because the blended amount of the silica was less than 30 parts by mass.

The rubber composition for a tire of Comparative Example 5 exhibits poor rolling resistance and temperature dependency thereof, because the blended amount of the silica is more than 100 parts by mass.

The rubber composition for a tire of Comparative Example 6 is poor in wear resistance, wet performance, low rolling resistance, and temperature dependency of rolling resistance, because the content of the silane coupling agent (coupling agent-1) represented by the average compositional formula of Formula (1) is less than 3 mass % of the silica mass.

The rubber composition for a tire of Comparative Example 7 exhibits poor wear resistance and cannot have reduced rolling resistance or temperature dependency thereof since the difference Tga-Tgm exceeds 10° C.

The rubber composition for a tire of Comparative Example 8 is poor in wear resistance, rolling resistance, and temperature dependency thereof because the Tg of the solution-polymerized styrene-butadiene rubber (SBR-3) was higher than −50° C.

The rubber composition for a tire of Comparative Example 9 is poor in rolling resistance and temperature dependency thereof because the Tg of the solution-polymerized styrene-butadiene rubber (SBR-4) was higher than −50° C.

1. A rubber composition for a tire, comprising:
100 parts by mass of a diene rubber comprising 55 mass % or more of a solution-polymerized styrene-butadiene rubber whose glass transition temperature is −50° C. or lower;
30 parts by mass or more and less than 100 parts by mass of a white filler; and
15 parts by mass or more of a thermoplastic resin,
from 3 to 20 mass % of a silane coupling agent represented by an average compositional formula of Formula (1) below being blended relative to a mass of the white filler,
the rubber composition for a tire satisfying a difference Tga-Tgm between Tga and Tgm of 10° C. or less,
where
Tga is a theoretical glass transition temperature of a mixture in which the diene rubber and the thermoplastic resin are blended at a mass ratio of 1:1, the theoretical glass transition temperature Tga being calculated from glass transition temperatures of the diene rubber and the thermoplastic resin, and
Tgm is a measured glass transition temperature of the mixture:
(A)ₐ(B)_{b}(C)_{c}(D)_{d}(R¹)ₑSiO_{(4-2a-b-c-d-e)/2} (1)
where in Formula (1), A represents a divalent organic group containing a sulfide group, B represents a monovalent hydrocarbon group having from 5 to 10 carbons, C represents a hydrolyzable group, D represents an organic group containing a mercapto group, R¹ represents a monovalent hydrocarbon group having from 1 to 4 carbons, and a to e satisfy the relationships: 0≤a<1, 0<b<1, 0<c<3, 0<d<1, 0≤e<2, and 0<2a+b+c+d+e<4.

2. The rubber composition for a tire according to claim 1, wherein a maximum value tan δ_{MAXA} of a loss tangent at from −40° C. to 60° C. of the rubber composition for a tire and a maximum value tan δ_{MAXB} of a loss tangent at from −40° C. to 60° C. of a rubber composition B having the same composition as that of the rubber composition for a tire except that all the thermoplastic resin is replaced with oil satisfy Formula (2) below in relation to the rubber composition B:
tan δ_{MAXA}/tan δ_{MAXB}>0.8 (2).

3. The rubber composition for a tire according to claim 1, wherein at least one terminal of the solution-polymerized styrene-butadiene rubber is modified with a functional group.

4. The rubber composition for a tire according to claim 1, wherein the thermoplastic resin has a glass transition temperature of from 40° C. to 120° C.

5. The rubber composition for a tire according to claim 1, wherein the thermoplastic resin is at least one selected from the group consisting of resins composed of at least one selected from terpenes, modified terpenes, rosins, rosin esters, C5 components, and C9 components, and resins in which at least some of double bonds of these resins are hydrogenated.

6. The rubber composition for a tire according to claim 1, wherein an oil extension amount of the solution-polymerized styrene-butadiene rubber is 10 parts by mass or less per 100 parts by mass of the solution-polymerized styrene-butadiene rubber.

7. A tire comprising: a tread portion comprising the rubber composition for a tire according to claim 1.

8. The rubber composition for a tire according to claim 2, wherein at least one terminal of the solution-polymerized styrene-butadiene rubber is modified with a functional group.

9. The rubber composition for a tire according to claim 8, wherein the thermoplastic resin has a glass transition temperature of from 40° C. to 120° C.

10. The rubber composition for a tire according to claim 9, wherein the thermoplastic resin is at least one selected from the group consisting of resins composed of at least one selected from terpenes, modified terpenes, rosins, rosin esters, C5 components, and C9 components, and resins in which at least some of double bonds of these resins are hydrogenated.

11. The rubber composition for a tire according to claim 10, wherein an oil extension amount of the solution-polymerized styrene-butadiene rubber is 10 parts by mass or less per 100 parts by mass of the solution-polymerized styrene-butadiene rubber.

12. A tire comprising: a tread portion comprising the rubber composition for a tire according to claim 11.
